(19) United States
(12) Patent Application Publication
(10) Pub. No.: US 2007/0284934 A1
(43) Pub. Date: Dec. 13, 2007

(54) Hub for assembly with straight spokes

(75) Inventor: Hubert Chen, Taichung Hsien (TW)

Correspondence Address: FOLEY AND LARDNER LLP;SUITE 500, 3000 K STREET NW, WASHINGTON, DC, 20007, US

(73) Assignee: Kun Teng Industry Co., Ltd.

(21) Appl. No.: 11/451,341

(22) Filed: Jun. 13, 2006

(51) Int. Cl. B60B 21/06

(52) U.S. Cl. 301/59

(57) ABSTRACT

A hub is provided to prevent straight spokes from pressing against each other. The hub includes spoke-mounting seats each having two first sides opposite to each other along an axis of the hub, two opposite second sides interconnecting the first sides, a first slot extending inwardly and axially from one of the first sides, a second slot extending inwardly and circumferentially from one of the second sides and meeting the first slot, a third slot extending inwardly and axially from the other first side, a fourth slot extending inwardly and circumferentially from the other second side and meeting the second slot, and a partition separating the first and second slots from the third and fourth slots. The second and fourth slots are staggered circumferentially and are inclined with a plane perpendicular to an axis of the hub.

### BACKGROUND OF THE INVENTION

1. Field of the Invention

The invention relates to a hub, particularly to a hub for assembly with straight spokes.

2. Description of the Related Art

FIGS. 1 and 2 show a typical hub used in a bicycle for assembly with a plurality of straight spokes 1 each of which has a spoke head 101 and a spoke stem 102. The hub includes a hub body 2 that has a peripheral wall 3 and a spoke-mounting part 4 disposed at one end of the peripheral wall 3. The spoke-mounting part 4 has first and second annular discs 401, 402 that extend around the end of the peripheral wall 3, and that define an annular groove 403 therebetween. The first annular disc 401 has a plurality of first axial through holes 404 each communicated with a radial opening 405. The second annular disc 402 has a plurality of second axial through holes 406 aligned respectively with the first axial through holes 404. The annular groove 403 has a width smaller than a cross section of each spoke head 101, whereas each opening 405 has a width smaller than a width of each first or second axial through hole 404, 406 and the cross section of each spoke head 101. The first and second axial through holes 404, 406 are larger than the spoke head 101. Therefore, each spoke stem 102 and the corresponding head 101 can be inserted respectively into the corresponding opening 405 and the corresponding first axial through hole 404. When the spoke stem 102 is turned and inserted into the annular groove 403, the spoke head 101 is pivoted and then engaged with the first and second axial through holes 404, 406.

As mentioned above, the spokes 1 can be attached to the spoke-mounting part 4 easily and quickly. However, when the spokes 1 are assembled with a wheel rim (not shown) to form a cross-type spoke configuration, the spokes 1 are inclined with respect to a plane perpendicular to an axis of the hub body 2. Since all the spoke stems 102 extend outward from the same annular groove 403 that extends substantially in a plane perpendicular to the axis of the hub body 2, when the spokes 1 extend from the hub body 2 to the wheel rim, spoke stems 102 will be bent and pressed against each other. As a result, stress concentration is likely to occur in the spoke stems 102, and the life span of the spokes 1 can be shortened.

### SUMMARY OF THE INVENTION

Therefore, an object of the present invention is to provide a hub with spoke-mounting seats, which prevent spokes from pressing against each other so that the stress concentration problem encountered in the prior art can be eliminated.

Accordingly, the present invention provides an improved hub for supporting a plurality of spokes each having a spoke head and a spoke stem. The hub comprises a tubular member, and a plurality of spoke-mounting seats projecting outwardly and substantially radially from the tubular member in an angularly spaced apart relationship. Each of the mounting seats has two first sides that are opposite to each other substantially along an axis of the tubular member, two opposite second sides that interconnect the first sides, an outermost face that is connected transversely to distal ends of the first and second sides, a first slot extending inwardly and substantially axially from one of the first sides and opening at the outermost face, a second slot extending inwardly and substantially circumferentially from one of the second sides and meeting the first slot inwardly of the one of the second sides, a third slot extending inwardly and substantially axially from the other one of the first sides and opening at the outermost face, a fourth slot extending inwardly and substantially circumferentially from the other one of the second sides and meeting the third slot inwardly of the other one of the second sides, and a partition that separates the first and second slots from the third and fourth slots. Each of the first and third slots has a constricted part opening at the outermost face, and an enlarged part disposed away from the outermost face. Each of the second and fourth slots has a cross section smaller than the size of the spoke head. The constricted part has a cross section smaller than the size of the spoke head. The enlarged part has a cross section larger than the size of the spoke head.

Advantageously, the second and fourth slots are staggered with each other in a circumferential direction of the tubular member, and are inclined with a plane perpendicular to the axis of the tubular member.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional hub;

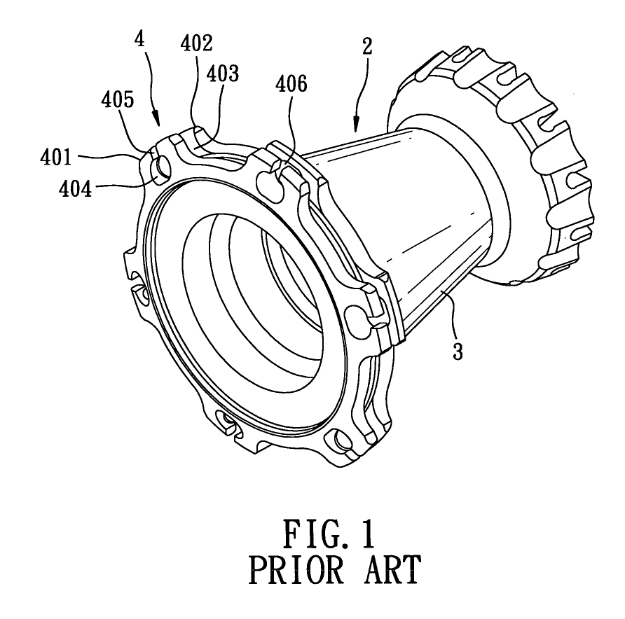

FIG. 2 is a perspective view of the conventional hub coupled with spokes;

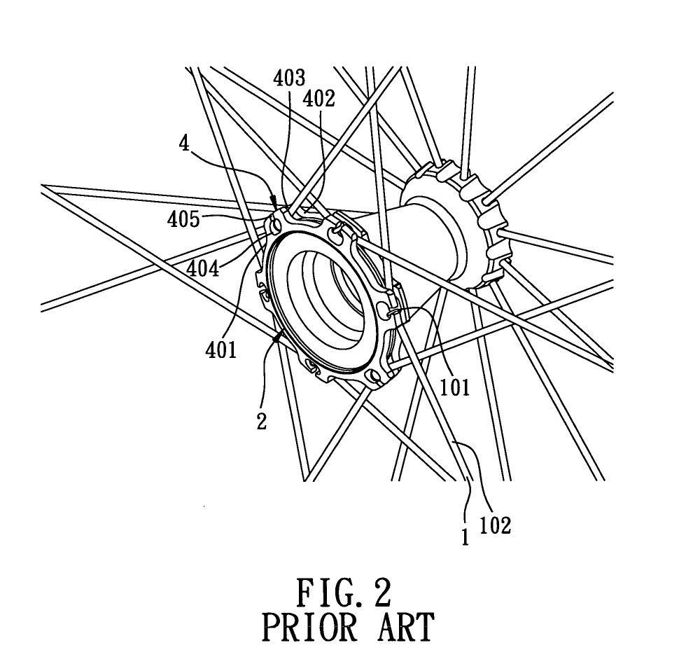

FIG. 3 is a side view of a hub embodying the present invention coupled with a wheel rim through spokes;

FIG. 4 is a partially sectioned view of the hub of FIG. 3;

FIG. 5 is a perspective view of the hub of FIG. 3;

FIG. 6 is a side view of the hub of FIG. 3; and

FIG. 7 is a sectional view taken along line 7-7 of FIG. 6.

### DETAILED DESCRIPTION OF THE PREFERRED EMBODIMENT

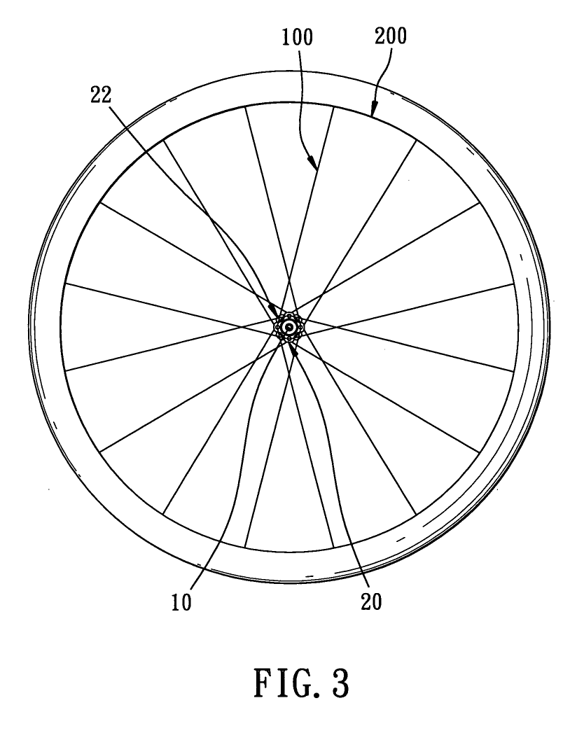

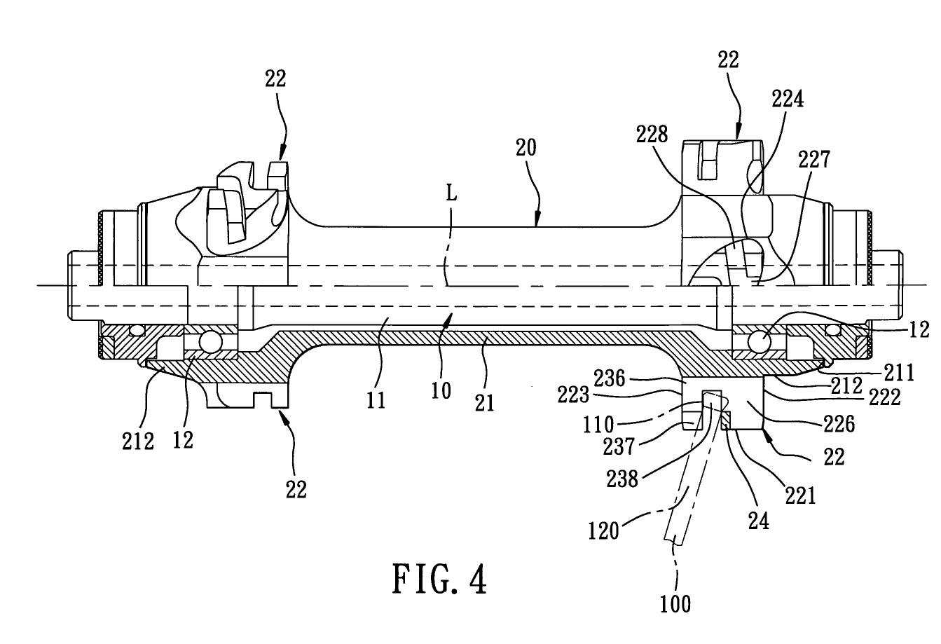

Referring to FIGS. 3 to 7, a preferred embodiment of the present invention is shown to include a hub 20 adapted to be assembled with a plurality of straight spokes 100 and a wheel rim 200. Each spoke 100 has a spoke head 110 to be fixed to the hub 20 and a spoke stem 120. The hub 20 is supported rotatably on a shaft unit 10 which includes a shaft 11 incorporating bearing assemblies 12.

The hub 20 has a tubular member 21, and a plurality of spoke-mounting seats 22 provided proximate to two opposite ends of the tubular member 21. Particularly, the tubular member 21 has two annular protrusions 212 proximate to the respective two ends of the tubular member 21. Four spoke-mounting seats 22 project outwardly from each annular protrusion 212 in an angularly spaced apart relationship.

Each spoke-mounting seat 22 has two opposite first sides 222, 223 that are opposite to each other substantially in an axial direction of the tubular member 21, two opposite second sides 224, 225 that interconnect the first sides 222, 223, an outermost face 221 that is connected transversely to distal ends of the first and second sides 222, 223, 224, and 225, a first slot 226 extending inwardly and substantially axially from the first side 222 and opening at the outermost face 221, a second slot 228 extending inwardly and substantially circumferentially from the second side 224 and meeting the first slot 226 inwardly of the second side 224, a third slot 236 extending inwardly and substantially axially from the other first side 223 and opening at the outermost face 221, a fourth slot 238 extending inwardly and substantially circumferentially from the other second side 225 and meeting the third slot 236 inwardly of the second side 225, and a partition 24 that separate the first and second slots 226, 228 from the third and fourth slots 236, 238.

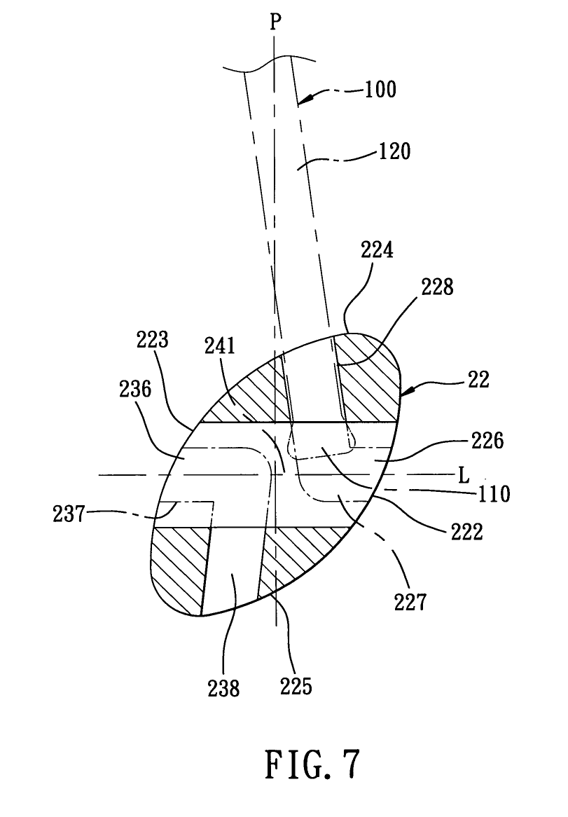

The second and fourth slots 228, 238 are inclined with a plane (p) perpendicular to an axis (L) of the tubular member 21, as shown in FIG. 7. The second and fourth slots 228, 238 are staggered with each other circumferentially of the tubular member 21. That is to say, the second and fourth slots 228, 238 are not aligned along the circumferential direction of the tubular member 21.

Each of the first and third slots 226, 236 has a constricted part 227, 237 opening at the outermost face 221, and an enlarged part 2261, 2361 disposed away from the outermost face 221. Each of the second and fourth slots 228, 238 has a cross section smaller than the size of the spoke head 110. The constricted part 227, 237 of each first or third slot 226, 236 has a cross section smaller than the size of the spoke head 110. Each enlarged part 2261, 2361 is provided with a cross section larger than the size of the spoke head 110 so as to permit the spoke head 110 to turn within the corresponding enlarged part 2261, 2361.

The partition 24 has a hole 241 that interconnects the enlarged parts 2261, 2361 of the first and third slots 226, 236. The hole 241 does not open at the outermost face 221 so that the constricted parts 227, 237 are separated by the partition 24.

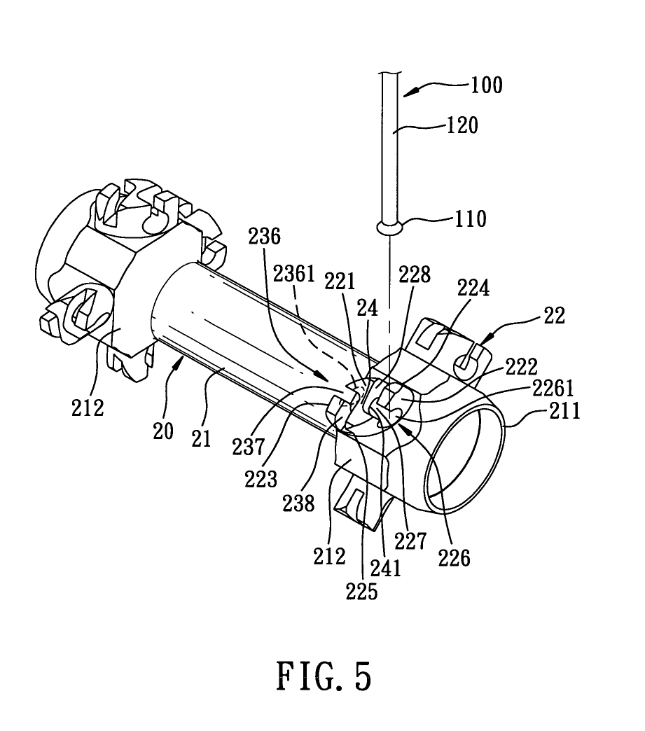

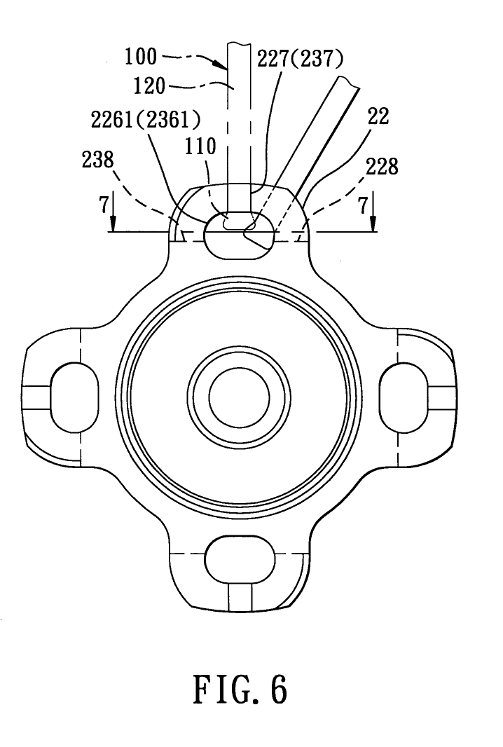

Each spoke-mounting seat 22 is used to hold two spokes 100. FIGS. 5, 6 and 7 show how to attach one of the spokes 100 to the corresponding spoke-mounting seat 22. Firstly, the spoke head 110 of the spoke 100 is inserted into the enlarged part 2261 of the first slot 226, and the spoke stem 120 thereof is inserted into the constricted part 227, as shown in FIGS. 5 and 6. When the spoke 100 reaches the partition 24, the spoke stem 120 is pivoted about the spoke head 110 and is inserted into the second slot 228, as shown in FIG. 7. The spoke stem 120 that projects from the spoke-mounting seat 22 is connected to the wheel rim 200, as shown in FIG. 3. As the spoke head 110 is larger than the cross section of the second slot 228, the spoke head 110 is restricted from moving into the second slot 228 and is engaged with the hole 241 and the enlarged part 2261. In addition, since the spoke stem 120 is inserted into the second slot 228, the spoke 100 is prevented from slipping through the first slot 226.

As described above, the construction of the spoke-mounting seats 22 is simple, and the spokes 100 can be attached to the spoke-mounting seats 22 rapidly and easily. Furthermore, the partition 24 that separates the second and fourth slots 228, 238 can prevent two spokes 100 attached to the same spoke-mounting seat 22 from interfering with each other. The spokes 100 need not be bent when attached to the hub 2, because the second and fourth slots 228, 238 are inclined with the plane (p) by angles predetermined according to the directions that the spokes 100 extend to the wheel rim 200. As the second and fourth slots 228, 238 are staggered with each other along the circumferential direction of the tubular member 21, the spokes 100 are spaced apart from each other and are thus prevented from pressing against each other. As such, stress concentration problems can be alleviated, and the life span of the spokes 100 can be increased.

While the present invention has been described in connection with what is considered the most practical and preferred embodiments, it is understood that this invention is not limited to the disclosed embodiment but is intended to cover various arrangements included within the spirit and scope of the broadest interpretation so as to encompass all such modifications and equivalent arrangements.

I claim:

1. A hub for supporting a plurality of spokes each having a spoke head and a spoke stem, said hub comprising:
a tubular member;
a plurality of spoke-mounting seats projecting outwardly and substantially radially from said tubular member in an angularly spaced apart relationship;
each of said spoke-mounting seats having two first sides that are opposite to each other substantially along an axis of said tubular member, two opposite second sides that interconnect said first sides, an outermost face that is connected transversely to distal ends of said first and second sides, a first slot extending inwardly and substantially axially from one of said first sides and opening at said outermost face, a second slot extending inwardly and substantially circumferentially from one of said second sides and meeting said first slot inwardly of said one of said second sides, a third slot extending inwardly and substantially axially from the other one of said first sides and opening at said outermost face, a fourth slot extending inwardly and substantially circumferentially from the other one of said second sides and meeting said third slot inwardly of said other one of said second sides, and a partition that separates said first and second slots from said third and fourth slots;
each of said first and third slots having a constricted part opening at said outermost face, and an enlarged part disposed away from said outermost face; and
each of said second and fourth slots having a cross section smaller than the size of the spoke head, said constricted part having a cross section smaller than the size of the spoke head, said enlarged part having a cross section larger than the size of the spoke head.

2. The hub as claimed in claim 1, wherein said partition extends to said outermost face and has a hole that intercommunicates said enlarged parts of said first and third slots and that does not open at said outermost face.

3. The hub as claimed in claim 1, wherein each of said second and fourth slots is inclined with a plane perpendicular to an axis of said tubular member.

4. The hub as claimed in claim 3, wherein said second slot is staggered with respect to said fourth slot along a circumferential direction of said tubular member.

5. The hub as claimed in claim 1, wherein said spoke-mounting seats are disposed around said tubular member proximate to two opposite ends of said tubular member.

6. A hub for assembly with a plurality of spokes each having a spoke head and a spoke stem, said hub comprising:
a tubular member;
a plurality of spoke-mounting seats projecting outwardly and substantially radially from said tubular member in an angularly spaced apart relationship;
each of said spoke-mounting seats having two first sides that are opposite to each other substantially along an axis of said tubular member, two opposite second sides that interconnect said first sides, an outermost face that is connected transversely to distal ends of said first and second sides, a first slot extending inwardly and substantially axially from one of said first sides and opening at said outermost face, a second slot extending inwardly and substantially circumferentially from one of said second sides and meeting said first slot inwardly of said one of said second sides, a third slot extending inwardly and substantially axially from the other one of said first sides and opening at said outermost face, a fourth slot extending inwardly and substantially circumferentially from the other one of said second sides and meeting said third slot inwardly of said other one of said second sides;
each of said first and third slots having a constricted part opening at said outermost face, and an enlarged part disposed away from said outermost face;
each of said second and fourth slots having a cross section smaller than the size of the spoke head, said constricted part having a cross section smaller than the size of the spoke head, said enlarged part having a cross section larger than the size of the spoke head; and
each of said second and fourth slots being inclined with a plane perpendicular to said axis of said tubular member.

7. The hub as claimed in claim 6, wherein said second slot is staggered with respect to said fourth slot along a circumferential direction of said tubular member.
